(19) United States
(12) Patent Application Publication
(10) Pub. No.: US 2002/0049273 A1
(43) Pub. Date: Apr. 25, 2002

(54) MULTI-CONSTITUENT STONE PUTTY

(76) Inventors: PETER SCHLINGELHOFF, POLLENFELD (DE); WILLIBALD KIRSCHNER, EUERWANG (DE); DIETER ZIMMERMANN, LANGENZENN (DE)

Correspondence Address: CHARLES R HOFFMANN, HOFFMANN & BARON, 6900 JERICHO TURNPIKE, SYOSSET, NY, 11791, US

(21) Appl. No.: 09/509,072

(22) PCT Filed: Sep. 22, 1998
(86) PCT No.: PCT/EP98/06027

(30) Foreign Application Priority Data
Sep. 24, 1997 (DE) 197 41 997.6
Oct. 18, 1997 (DE) 197 46 170.0

(51) Int. Cl. C08K 3/18; C08K 3/34

(52) U.S. Cl. 524/430; 524/442; 524/451; 524/433

(57) ABSTRACT

Proposed are system putties comprising three components, wherein component I is an accelerated stone putty and component II is a non-accelerated stone putty containing at least one stabilizer and component III contains at least organic peroxide.

The present invention concerns a multi-component stone putty based on unsaturated polyester resins or acrylic resins, in particular for processing by machine, with pigments and filling and structure substances.

A stone putty of that kind is known for example from Utility Model DE-295 08 712 U1 and is referred to therein as a structure putty. That structure putty is in substance based on cold-setting two-component polyester resins or cold-setting two-component epoxy resins. A multi-component stone putty of that kind, besides being used as a putty material, is also used as a jointing material or restoration or filling material for artificial or natural stones, in which respect the filled joints or locations after setting of the putty material generally have to be matched to the stone material by grinding and polishing.

The multi-component stone putty known from the state of the art however suffers from the disadvantage that it only enjoys medium workability because a sediment which can scarcely be homogenized again is already formed after a certain storage time.

Further disadvantages are a relatively low degree of storage stability, moderate stability in regard to mixing of the components, and relatively slow thorough setting in spite of a relatively short processing time.

Therefore the object of the present invention is to provide a multi-component stone putty which is easier to work with, which does not suffer from at least some of the disadvantages known from the state of the art and which is economical to produce, and which can be used and processed as far as possible with a uniform level of quality.

That object is attained by a system putty of the kind set forth in the opening part of this specification, in that it comprises three components, wherein component I is an accelerated stone putty and component II is a non-accelerated stone putty containing at least one stabilizer, and component III contains at least one organic peroxide.

It is further advantageous in this respect if component I and/or component II also contains at least one rheological additive and/or at least one drying additive. It is particularly preferred if component III is formed by at least one organic peroxide which is stabilized in a plasticizer, in particular dibenzoyl peroxide.

The multi-component stone putty according to the invention affords the particular advantage that better processing by machine is now possible, while a further advantage is that a constant and correct mixing ratio for the components is guaranteed, as well as good mixing thereof. That results in particular in excellent grinding and polishing properties for the stone putty when set, as can scarcely be achieved with manual working. A further advantage is excellent filling of relatively small and also relatively large holes by virtue of automatic smoothing and levelling and the level of quality which always remains the same and which is not dependent on the qualification and capabilities of the person doing the work.

In comparison with the products known from the state of the art, the multi-component stone putty according to the invention is also of a substantially more stable consistency, that is to say a substantially lesser degree of creaming and settlement occurs. A sediment which can no longer be dispersed is only formed, if at all, after an extremely long storage time. Further advantages are better storage stability as well as better durability of the mixture of components.

When the multi-component stone putty according to the invention is used firstly a suitable amount of component III with the organic peroxide is mixed with component II. By virtue of the at least one stabilizer contained in component II, that mixture is stable for working thereof for at least 3 days. Component I and the mixture of components II and III are preferably used and processed in a quantitative ratio of substantially 1:1. In a processing operation using a machine component I and the mixture of components II and III are each introduced into a suitable storage container and conveyed through pressure conduits to the processing location where, after issuing from the pressure conduits, they are mixed and filled in.

That mode of operation affords a substantially more uniform level of distribution and mixing of the components than is possible with the conventional stone putties. More specifically, a mixing ratio of 100:1 to 100:4 for the mixing of stone putty and initiator, as is conventional in the state of the art, is extremely difficult to implement. When manual operation is involved, generally an estimate is made when measuring out a suitably adequate amount of initiator and in addition homogenous distribution of the initiator in the stone putty is scarcely something that can be achieved. Those disadvantages are overcome with the multi-component stone putty according to the invention, while in addition the available processing time is longer than with the known stone putty. Surprisingly, nonetheless faster thorough hardening of the putty was achieved, so that the worked and filled stone surface can also be more quickly moved on for final treatment, for example a grinding and polishing operation.

Particularly emphasis is to be laid on a specific fluid organic peroxide as component III, which after mixing of the components results in a soft thixotropic structure for the mixture. That results in an excellent filling and working consistency, in which respect sinking of the putty when it has not yet set is avoided or at least greatly reduced, even when dealing with relatively large holes.

In a preferred composition of the multi-component stone putty component I contains:

between 20 and 60% by weight of binding agent

between 0 and 5% by weight of accelerator

between 0.5 and 10% by weight of rheological additive

between 0 and 5% by weight of organic and inorganic pigments

between 0 and 70% by weight of inorganic filling substances

between 0 and 30% by weight of structure substances, and

between 0.1 and 0.5% by weight of drying additives

In that respect component II contains:

between 20 and 60% by weight of binding agent

between 0 and 5% by weight of stabilizer

between 0.5 and 10% by weight of rheological additive

between 0 and 5% by weight of organic and inorganic pigments

between 0 and 70% by weight of inorganic filling substances

between 0 and 30% by weight of structure substances, and

between 0.1 and 0.5% by weight of drying additives.

Component III preferably comprises 50% by weight of dibenzoyl peroxide which is stabilized in a plasticizer.

The binding agents used in the multi-component stone putty according to the invention are unsaturated polyester resins or acrylic resins prior to or dissolved in a monomer such as for example styrene, α-methylstyrene, hexanedioldimethacrylate or methylmethacrylate. The unsaturated polyester resins or acrylic resins used contain in component I an accelerator such as for example N,N-dimethyl-p-toluidine, N, N-di-2-hydroxyethyl-p-toluidine, dimethylaniline or a metal such as Co or metallorganic compounds such as for example Co-octoate. Contained in component II are phenols or quinones as stabilizers, in which respect examples that can be mentioned are compounds such as hydroquinone, t-butylcatechol, p-benzoquinone, naphthoquinone and chloranil.

The rheological additives used in the multi-component stone putty are preferably, in unmodified form or modified with organic groups such as for example alkyl groups, precipitated or highly dispersed silicic acids, hardened or unhardened castor oil derivatives, unmodified or organically modified stratified silicates and polyamides. The drying additives preferably used are paraffins or synthetic derivatives derived from paraffins.

An entire series of filling substances which are generally known and used in this field are available to the man skilled in the art as the filling substances, but in that respect in particular talc, barite, calcite, dolomite, quartz powder, aluminum oxide or hydroxide and kaolin are preferred. Appropriately the grain size of those filling substances is in the range of between 0.1 and 150 μm.

Mica, pearly pigments, metal effect pigments and coarse kinds of talc are to be particularly mentioned as so-called structure substances which permit better adaptability to the wide range of variations in natural stones.

The pigments which are usually employed are also basically known to the man skilled and active in the present art and can be selected from a large number of natural and synthetic pigments, both of organic and organic nature. Here for example oxides of titanium, iron, chromium, cobalt as well as soots and blacks are primarily mentioned as examples of inorganic pigments and phthalocyanines and azo dyes are mentioned as examples of organic pigments. The latter are preferably used.

The present invention will now be described in greater detail with reference to the following Example.

### EXAMPLE

Component I:

350 g of unsaturated polyester resin dissolved in styrene is mixed with 7 g of amine accelerator, 9 g of Theological additives, 0.7 g of titanium dioxide, 0.7 g of iron oxide pigments and 1.5 g of drying additives and dispersed in a high-power agitator.

Component II:

350 g of unsaturated polyester resin dissolved in styrene is mixed with 1 g of stabilizer, 9 g of rheological additives, 0.7 g of titanium dioxide, 0.7 g of iron oxide pigments and 1.5 g of drying additives and dispersed in a high-power agitator.

Component III:

The third component is a 50-% mixture of dibenzoyl peroxide in plasticizer, wherein the dibenzoyl peroxide is mixed with the plasticizer for stabilization purposes.

Processing:

6% by weight of component III is added to component II and the two constituents are thoroughly mixed together. That mixture is stable for use and processing for at least 3 days.

For further use and processing component I and the mixture of components II and III are mixed in a ratio of 1:1 and worked and filled in. This can be effected manually and also by machine.

When processing the material by machine, component I is introduced into a suitable pressure container, as well as the above-described mixture of components II and III. Component I and the mixture of components II and III are then conveyed by way of suitable pressure conduits to the processing location where they issue from the conduits and are mixed and worked and filled in.

The mixture of component I with the mixture of components II and III remains workable for between about 2 and 3 minutes and hardens after a further 10 minutes to such an extent that the filled and levelled stone surface can be ground and polished.

It will be apparent from this example that only an extremely small mistake can occur in regard to measuring off the initiator because, in particular for processing by machine, it is possible to prepare special, mutually matched packaging sizes for the individual components and the manner of manufacture of the mixture of component II with the initiator, that is to say the hard component III, means that only two approximately equal volumes have to be mixed together for definitive processing, whereby a possible mistake in terms of quantitative measurement of the initiator is kept within very low limits. In addition that ensures homogenous distribution of the initiator throughout the entire stone putty.

1. A multi-component stone putty based on unsaturated polyester resins or acrylic resins, in particular for processing by machine, with pigments and filling and structure substances, characterised in that the multi-component stone putty comprises three components, wherein component I is an accelerated stone putty and component II is a non-accelerated stone putty containing at least one stabilizer and component III contains at least one organic peroxide.

2. A multi-component stone putty as set forth in claim 1 characterised in that component I and/or component II further contains or contain at least one rheological additive and/or at least one drying additive.

3. A multi-component stone putty as set forth in claim 1 or claim 2 characterised in that component III is formed by at least one organic peroxide which is stabilized in a plasticizer.

4. A multi-component stone putty as set forth in claim 2 or claim 3 characterised in that component I and component II each contain
between 20 and 60% by weight of binding agent,
between 0.5 and 10% by weight of Theological additive,
between 0 and 5% by weight of organic and/or inorganic pigments,
between 0 and 70/ by weight of inorganic fillers,
between 0 and 30% by weight of structure substances, and
between 0.1 and 0.5% by weight of drying additive,
wherein component I further contains between 0 and 5% by weight of accelerator while component II contains between 0 and 5% by weight of stabilizer.

5. A multi-component stone putty as set forth in one of claims 2 through 4 characterised in that one or more components selected from precipitated or highly dispersed silicic acid which is unmodified or modified with organic groups, hardened or unhardened castor oil derivatives, stratified silicates which are unmodified or organically modified and polyamides are contained as the rheological additive.

6. A multi-component stone putty as set forth in one of the preceding claims characterised in that paraffins or derivatives synthetically derived therefrom are contained as the drying additive.

7. A multi-component stone putty as set forth in one of the preceding claims characterised in that one or more of talc, barite, calcite, dolomite, quartz powder, aluminum oxide or hydroxide and kaolin are contained as the filler.

8. A multi-component stone putty as set forth in one of the preceding claims characterised in that the filling substances are of a particle size of between 0.1 and 150 μm.

9. A multi-component stone putty as set forth in one of the preceding claims characterised in that mica, pearly pigment or pigments, metal effect pigment or pigments and/or coarse kinds of talc are contained as structure substances.

10. A multi-component stone putty as set forth in one of the preceding claims characterised in that component I contains tertiary aromatic amines, metals or metallorganic compounds as the accelerator.

11. A multi-component stone putty as set forth in one of the preceding claims characterised in that component II contains phenols and/or quinones as the stabilizers.

12. A multi-component stone putty as set forth in one of the preceding claims characterised in that component III contains dibenzoyl peroxide as the organic peroxide.

13. Use of a multi-component stone putty as set forth in one of claims 1 through 12 characterised in that firstly a mixture of components II and III is produced, which is substantially mixed with an approximately equal volume of component I.
